(19) United States
(12) Patent Application Publication
(10) Pub. No.: US 2008/0128568 A1
(43) Pub. Date: Jun. 5, 2008

(54) Foot stand

(75) Inventor: I-Tsen Chen, Taipei (TW)

Correspondence Address: BIRCH STEWART KOLASCH & BIRCH, PO BOX 747, FALLS CHURCH, VA, 22040-0747, US

(73) Assignee: RELIANCE INTERNATIONAL CORP.

(21) Appl. No.: 11/606,081

(22) Filed: Nov. 30, 2006

(51) Int. Cl. F16M 11/00

(52) U.S. Cl. 248/125.8

(57) ABSTRACT

An improved foot stand located on a lower end of a supporting stand which holds a liftable concert article such as a microphone, music score or musical instrument includes a base, a balance weight and a post. The balance weight is located in the base. The post is connected to the upper side of the balance weight in a vertical manner. Through the balance weight the supporting stand does not topple after receiving an external force and being tilted slightly. The post of the supporting stand can also return to the vertical condition after tilted.

### BACKGROUND OF THE INVENTION

1. Field of the Invention

The present invention relates to a foot stand and particularly to a foot stand located on a lower end of a supporting rack which holds a concert article in a liftable manner.

2. Brief Discussion of the Related Art

A conventional foot stand, referring to R.O.C. patent publication No. 375346 for an example to hold a microphone, mainly aims to hold a post with the top end latching on a holding rack to hold the microphone at a front end thereof. Its features include an anchor post, a fastening dock, an anchor seat, an adjustable rack and a fastening element. The fastening dock has a through hole on one end and a screw hole on one side of the one end normal to the through hole. The anchor seat has another through hole on one end corresponding to the through hole of the fastening dock. For assembly the upper side of the anchor post is fastened to the fastening dock and another end of the anchor seat that does not have the another through hole. The adjustable rack runs through the through holes of the fastening dock and the anchor seat and is movable to a desired location, then a fastening element can be fastened in the screw hole to brake and anchor the adjustable rack. It has a tripod base which needs a greater supporting area. When in use the tripod is frequently kicked by people incidentally. To remedy this problem one of approaches is to adopt a foot stand consisting of a flat bottom surface at a smaller supporting range. While such an approach improves the kicking problem of the conventional tripod foot stand, it creates another problem by forming an unstable gravity center. For instance, in a concert the supporting rack with the foot stand at the lower end usually aims to hold a liftable concert article, such as a microphone, music score or musical instrument. Those articles are frequently touched by performers during the concert. A shrunk foot stand on the lower end of the supporting rack tends to skew the gravity center from the vertical line while holding the concert article. Hence the supporting rack is easily tilted and toppled. The costly microphone or musical instrument held on the supporting rack could drop to the floor and be damaged. A great loss could occur. Hence how to provide an improved foot stand to allow the supporting rack to return by itself after the gravity center is skewed from the vertical line is an issue pending to be resolved in the industry.

### SUMMARY OF THE INVENTION

Therefore the primary object of the present invention is to solve the aforesaid problem. The invention provides a foot stand that can prevent a supporting rack from toppling when subject to an external force and tilted slightly. It also enables the post of the supporting rack to return to a vertical condition after tilted.

The foot stand according to the invention is located on a lower end of a supporting rack which holds a liftable concert article. The concert article may be a microphone, music score, or musical instrument. The foot stand includes a base which has an arched portion and a bottom, a balance weight located within the bottom with the weight decreasing gradually from a lower side to an upper side and a center screw hole on an upper side, and a post to hold the liftable concert article that has a threaded portion fastenable with the center screw hole. With the aid of the balance weight, the foot stand does not topple when it is slightly tilted under an external force, and can return to the vertical condition after tilted.

Further scope of the applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is an exploded view of an embodiment of the invention

FIG. 2 is a perspective view of an embodiment of the invention.

FIG. 3 is a side view of an embodiment of the invention.

FIG. 4 is a schematic view of an embodiment of the invention in a use condition.

### DETAILED DESCRIPTION OF THE PREFERRED EMBODIMENTS

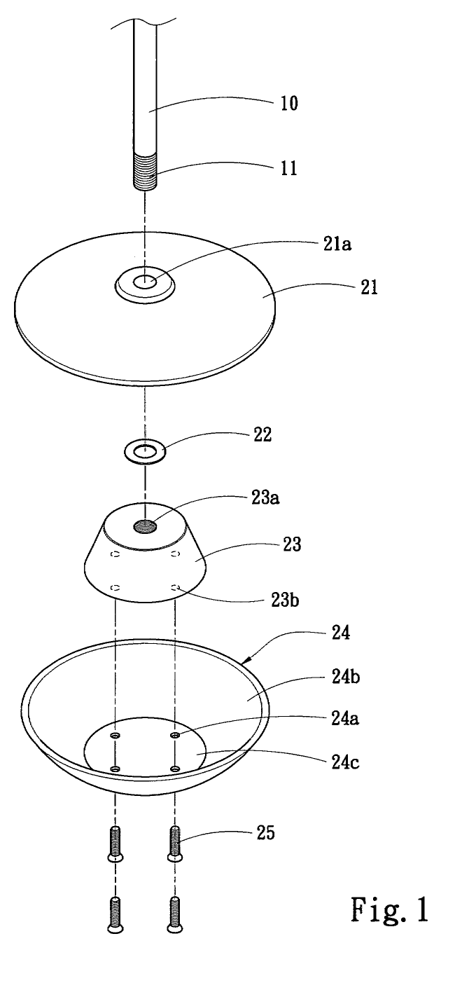

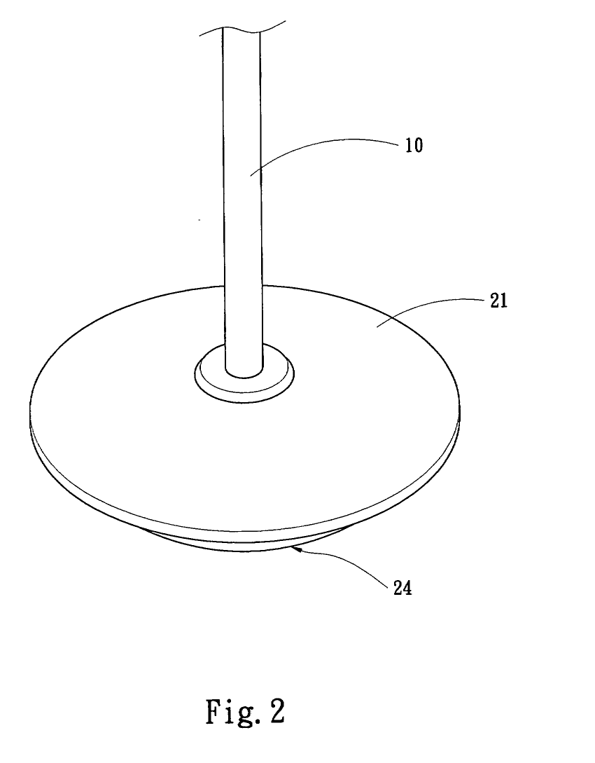

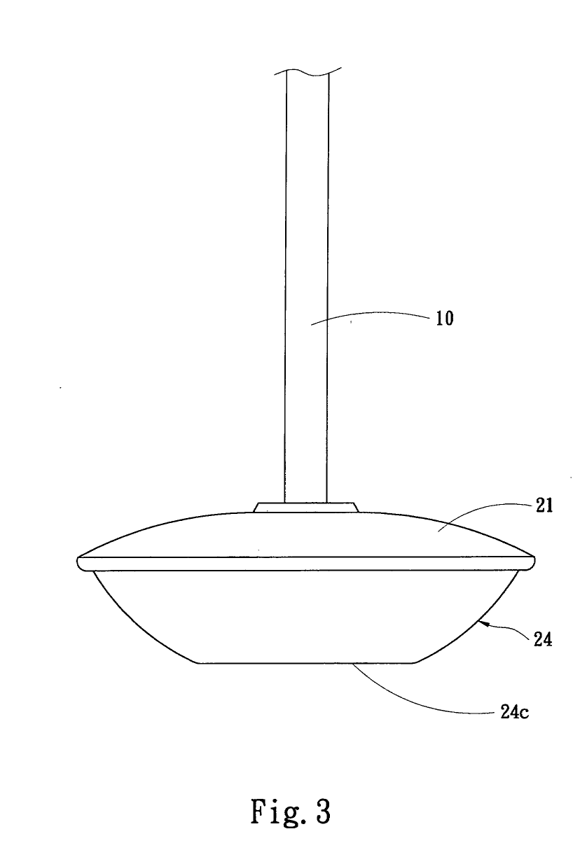

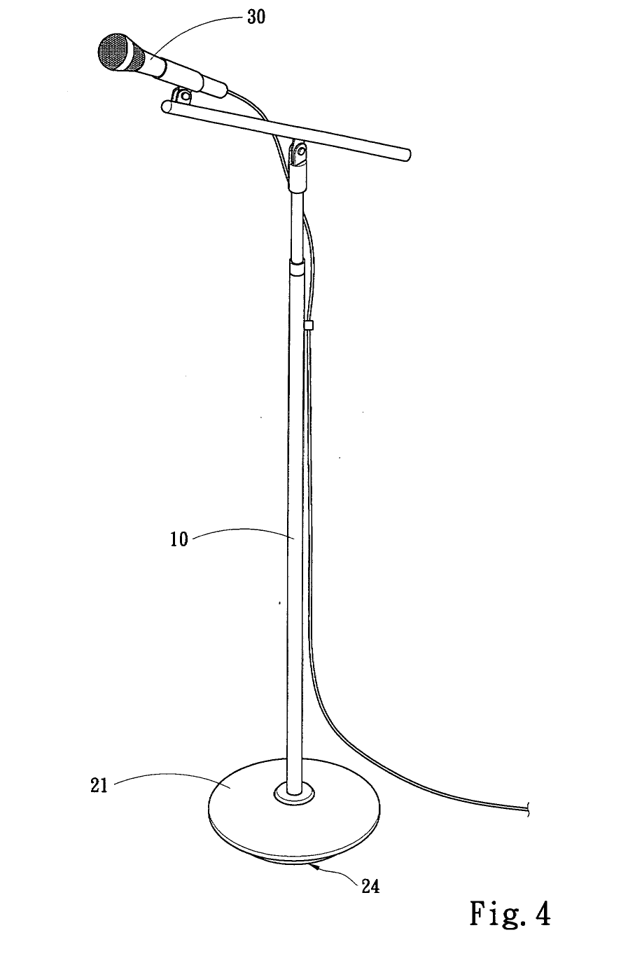

Please refer to FIGS. 1, 2 and 3 for an embodiment of the foot stand of the invention. It includes a base 24 which has a flat bottom 24c and an arched portion 24b extended from the bottom 24c, and a balance weight 23 located within the range of the bottom 24c. The balance weigh 23 has a center screw hole 23a on an upper side that has an internal screw thread formed thereon. A post 10 is provided to hold a concert article (such as a microphone 30 shown in FIG. 4) which may be lifted to a desired elevation. The post 10 has a threaded portion 11 on a lower side with an external screw thread formed thereon to be fastened with the center screw hole 23a of the balance weight 23 in a vertical manner against the bottom 24c. There is also an upper cap 21 on the upper side of the base 24 mating the base 24. The upper cap 21 has an opening 21a corresponding to the center screw hole 23a to be run through by the post 10. The post 10 also is coupled with a washer 22 interposed between the balance weight 23 and the upper cap 21. The bottom 24c has a plurality of apertures 24a to be run through by fastening elements 25 to fasten with corresponding screw holes 23b formed on a lower side of the balance weight 23. The bottom 24c is a flat surface to hold the balance weight 23. The arched surface 24b is extended from the bottom 24c. When in use during a concert the concert article held on the post is frequently touched by performers and results in skewing of the gravity center from the vertical line. The foot stand of the invention constructed as previously discussed can prevent the concert article from toppling or dropping. Even if the foot stand of the invention is tilted, the arched portion 24b is in contact with the floor surface, and the gravity of the balance weight 23 on the bottom 24c is greater than the tilting gravity force caused by skewing of the gravity center, hence toppling of the concert article can be prevented, and returning to the vertical condition takes place after tilted.

Refer to FIG. 4 for an embodiment of the invention in a use condition. As the bottom 24c is a flat surface holding the balance weight 23, and the arched portion 24b is an arched surface extended from the bottom 24c, when the microphone 30 is touched by performers during the concert, the gravity center is skewed and the vertical line is tilted, but it does not topple. This is because the arched portion 24b is in contact with the floor surface while the foot stand is tilted, and the gravity of the balance weight 23 on the bottom 24c is greater than the tilting gravity force, thus the foot stand of the invention not only can prevent the microphone 30 from toppling after being tilted, it also can return to the vertical condition after tilted.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

1. A foot stand located on a lower end of a supporting stand which holds a liftable concert article including a microphone, a music score or a musical instrument, comprising:
a base which has a flat bottom and an arched portion extending between the flat bottom and an outer side of the base, wherein the flat bottom has a size sufficiently large to provide the stand with stable equilibrium;
a balance weight which is located within the range of the bottom and gradually decreases in weight from a lower side towards an upper side thereof, and which has a center screw hold on the upper side thereof;
a post which is fastened to the upper side of the balance weight and vertical to the bottom to hold the liftable concert article; and
an upper cap which is located above the base to mate with the base, the upper cap having an opening corresponding to the center screw hole to be run through by the post.

2. The foot stand of claim 1, wherein the bottom has a plurality of apertures to receive fastening elements to fasten to corresponding screw holes formed on the lower side of the balance weight.

3-4. (canceled)

5. The foot stand of claim 1, wherein the post has a threaded portion fastenable with the center screw hole to be anchored on the balance weight.
